(19) United States
(12) Patent Application Publication
(10) Pub. No.: US 2012/0330707 A1
(43) Pub. Date: Dec. 27, 2012

(54) WEB-BASED COMMUNICATION PLATFORM

(76) Inventor: MICHAEL LOUCKS, SEBASTOPOL, CA (US)

(21) Appl. No.: 13/528,816

(22) Filed: Jun. 20, 2012

Related U.S. Application Data
(60) Provisional application No. 61/500,690, filed on Jun. 24, 2011.

(51) Int. Cl. G06Q 10/06

(52) U.S. Cl. 705/7.13

(57) ABSTRACT

A web platform including a number of general product profile pages, a number of specific product profile pages, a product owner module, a product technician module, and an access feature.

### CLAIM OF PRIORITY

This application claims the benefit of priority of U.S. Provisional Patent Application Ser. No. 61/500,690, filed on Jun. 24, 2011.

### FIELD OF THE INVENTION

The present invention relates to web communication platforms, and in particular, to web integration of hardware maintenance.

### BACKGROUND

All manner of gadgets, from home printers to airplanes, need maintenance over the course of their useful lives. Currently, execution of such maintenance requires the navigation of a hodgepodge of information and the cooperation of several parties. Necessary or helpful maintenance or repair information may include past work history on the product (if recorded), manufacturer information, warranty information, parts requirements, suggested maintenance schedules, and of course, the nature of any current problems with the product. This information may be spread between the manufacturer of the product, the owner of the product, the product installer when applicable, and any technicians that have worked on the product in the past. A technician attempting to work on a damaged product may have access to very little of this information. In some cases, the technician will not be able to repair or maintain a product without this information. Even in cases where the technician is successful without all the information, he or she would likely have been more efficient with it.

In addition to the problem of scattered information, the owner of a product has the further disadvantage of not necessarily knowing if the technician is qualified to work on the product. The owner has few tools to learn the background, experience, and qualifications of the technician. The owner may be interested in knowing more about the technician before allowing the technician access to the owner's valuable products.

Therefore there is a need for a streamlined, integrated platform for warehousing information about products and product technicians, and access to such a warehouse for product manufacturers, technicians, and product owners.

### SUMMARY OF THE INVENTION

The present invention is a web platform, a software product for executing the web platform, and a method for administering the web platform.

Each of these aspects of the present invention is a part of an exemplary system illustrated by the following example: A garbage disposal is purchased. The owner registers the serial number of that particular garbage disposal with the web platform of the present invention. The web platform already includes a general product profile page for the product including a great deal of information specific to that specific product model including its manual and warranty information. By registering his specific product with the web platform, the owner creates a specific product profile page specific to his particular product that includes all of the information included in the general product profile page, as well as any specifics provided by the owner, such as serial number, date of purchase, place of purchase, price, etc. . . . .

Years later, the owner of a garbage disposal discovers that the garbage disposal is not working. The owner logs into his specific product profile page. After perusing the information provided the owner decides to bring in a technician to repair the garbage disposal.

Through the specific product profile page of the web platform, the owner puts in a request for a repair technician to come to his home. This request is relayed to a local company that is also a user of the web platform. This local company employees a number of technicians. A qualified technician arrives and scans the QR Code on the garbage disposal with his work smartphone or tablet. The scanning brings the technician to the general product profile on the web platform. He then clicks on a request connection button and a request is sent to the product owner asking for permission to access the specific product profile for the owner's specific garbage disposal. Upon the owner allowing access, the technician is given access to information about the garbage disposal, including the date of its installation, the user's manual, warranty information, past repair history, etc. The technician completes his work, adding a ticket close-out, which is a record of his work that day that will be visible for the next qualified person who scans the code on the garbage disposal. He may also include notes for future technicians about that specific product in the ticket close-out. The technician's supervisor may evaluate the technician's performance based on the time spent at the job, recorded as the time between the initial scan and the ticket close-out. Upon leaving, the technician receives an alert about his next job on his smartphone, through the web platform. This job will be to repair a piece of equipment that he is certified to work on. Directions and other information for the next job are included in the alert.

As illustrated in the narrative above, the purpose of the web platform is to facilitate product information sharing between a number of users, but at least product owners and product technicians. In its most basic form, the web platform of the present invention include a plurality of general product profile pages, a number of specific product profile pages, a product owner module, a product technician module, and an access module.

Each product included in the database of the web platform has a general product profile page. The general product profile page includes general information common to all products of a certain model. Some of this general information will be provided by manufacturers, such as specifications, maintenance recommendations, the product manual, warranty information, and links to company website support. A manufacturer may provide general information for every type of product they sell and/or make. Product information may also be provided by existing product databases, such as those available from the Air-Conditioning, Heating, and Refrigeration Institute (AHRI), the Consortium for Energy Efficiency (CEE), and Energy Star. The manufacturers or other companies that make or sell parts or complementary products may also include information about the product and how to order parts for it through the web platform. If the product is a printer, for example, information about the type of toner that the printer takes and how to order it through the web platform may be included. Information from CEE and/or Energy Star, for example, may pertain to tax incentives or government energy credits associated or available with the product.

The web platform also includes specific product profile pages. As each general product profile page will include general information common to a specific model of a product, which may be owned by thousands of people, each specific product profile page includes specific information specific to a specific serial number of a specific model of a product. Therefore the specific product profile pages include all of the general information included in the general product profile page, as well as specific information specific to an individual product. Much of the specific information included in the specific product profile page is provided by product owners about the specific owned product. Registration of the product with the manufacturer by product serial number may be linked to registration of the product with the web platform. This will establish date of purchase, which may be linked with the life of manufacturer warrantees. Alternatively, the product owner may register the product with the web platform directly. In either way, the product registration with the web platform creates a specific product profile page for the owner's specific product and serial number.

Each product will include a visible code, preferably a QR code. A product owner may register the product with the manufacturer and/or the web platform by scanning the QR code, with a smartphone, tablet, or other device capable of scanning a QR code. Alternatively, the product owner may register the product directly through the web platform, without scanning the code. As the product is used, more specific information will be included about that specific product on its specific product profile page, including repair history provided by technicians as repair and maintenance is performed on the product and accumulated tax energy credits if applicable. The web platform of the present invention could be used to gather information for virtually any type of product. Specific target markets may include, but are not limited to, home and industrial appliances, medical equipment, home electronics, automobile, and aviation.

In some embodiments of the web platform, one or more of the specific product profile pages may include means for tracking tax credits associated with the product detailed in the specific product profile page. In such embodiments, the specific information includes the tax credit accumulation tracked by the tracking means.

The main aspects of the web platform will be a database of general and specific product profile pages with varying levels of access. Information stored in the web platform's database will be easily accessible to the various users of the web platform and will be easily integrated with existing user applications through standard XML data exchange. Information stored in the database, such as manufacturer product information and technician certification numbers, is integrated in a variety of ways, including automated export, instantaneous retrieval, and work order requests.

The web platform also includes a product owner module. The product owner module includes a specific product feature and a work request feature. The specific product feature allows the product owner to enter specific information about his or her individual product, as described above. The specific information may also include information about the product owner, such as his or her address. The work request feature allows the product owner to request repair or maintenance work on the individual product directly through the product's specific product profile page. The work request will be relayed to a qualified technician in the owner's geographical area.

The web platform also includes a product technician module. The product technician module includes a ticket commencement feature, a history feature, a note taking feature, and a ticket close out feature. The ticket commencement feature time stamps when the technician began work on an individual product. The ticket commencement feature may be activated by the technician scanning the product, the technician logging into the web platform, or the technician being granted access to the individual product's specific product profile page. The history feature gives the technician access to past technician history on the product. This may be the technician's personal history of work on any products that are the individual product's model; the technician's personal history of work on that specific individual product; all technician's history of work on any products that are the individual product's model; or all technicians' history of work on that specific individual product. Past history in this case refers to notes concerning work on the product, work performed on the product, past part requests, etc. . . . . The note taking feature allows the technician to make notes on his or her present experience working on the product and to include these notes on the individual product's specific product profile page. The ticket close out feature time allows the technician to indicate completion of the work on the individual product and time stamp that completion.

The web platform also includes an access module. The access module includes a general access feature and a specific access feature. The general access feature allows users access to the general product profile pages. In particular, when a technician scans a product, he or she will be granted access to the product's general product profile page. The specific access feature allows users access to the specific product profile pages. The specific access feature includes an access request feature, an alert feature, and a permission feature. The access request feature allows the technician to request access to the individual product's specific product profile page. This may occur simply by scanning the product. This may occur through the general product profile page by entering the product's serial number, for example. This may occur automatically upon the technician scanning the product, owner permission being assumed by the technician's physical access to the product. The alert feature lets the owner know through the web platform that the technician has requested access. The permission feature allows the owner to permit access once he or she is alerted as to the technician's request.

In some embodiments, the database may also contain information about technicians. This information may come from several sources. Some information, such as basic demographics, may be supplied by the technician himself or herself. This demographic information provision may be part of the technician creating an account for himself or herself with the web platform. Other information, such as certifications in certain states or for certain technologies or specific products, may be provided by a certifying authority. The certifying authority may be states or other jurisdictions, vocational schools or other educational institutes, technical professional organizations, such as North American Technician Excellence (NATE), or any other organization with which the web platform master partners for this purpose.

The database will manipulatable for a variety of data analyses. Such data analysis may be related to repair costs, number of a certain type of product, number of products from one manufacturer versus number of similar products from another manufacturer, technician efficiency, geographical distribution of products, etc. . . . . One of ordinary skill in the art will recognize the scope of the data contained in the data base and the many ways it may be analyzed. In some embodiments, information from the database and analysis thereof may be sold to market analysts. The database will also have a variety of billing and invoice tools for billing the various users of the web platform.

In some embodiments, the database will include information on product certifications. This part of the database will be mainly geared toward technicians and technician supervisors. The information provided may include information on the requirements for certification to work on various products and opportunities to gain the requisite training to achieve those certifications.

There are four main sets of users of the web platform: product manufacturers, product owners, technician supervisors, and technicians. Product manufacturers will benefit from providing easy access to all information about their products. This will decrease their customer service needs and increase customer satisfaction with the products. Product manufacturers have access to the information they provide about their various products, and information provided by product owners during product registration. In addition, different levels of access to information regarding the life of the product may also be bestowed upon the manufacturers. For example, product manufacturers may be allowed to gather information about performance, maintenance, and repair of their products through the work records provided by technicians on products' specific profile pages. This may require permission from the product owner, the technician, or both. Alternatively, manufacturers may not have access to individual work records, but may be able to do basic word analytics to find words that occur frequently in the work records. This information might be for development and marketing or engineering analysis purposes, and would not include personal information of the product owners without their permission.

Product owners will benefit in knowing that the technicians working on their products are qualified to do so. Product owners will also benefit in having all the information about their products easily accessible through the web platform by scanning the code on their products or logging into their web account. In some cases, the product owner's problem may be as simple as ordering a new part through the web platform. For more difficult issues, product owners may easily request repair assistance through the web platform. Additionally, product owners may sign up to receive maintenance reminders through the web platform. Technicians called in for such work may perform preventive and/or predictive maintenance to extend the product's life. Product owners may have access to general product information provided by the manufacturer, product information specific to the product they own, and some or all information about technicians certified to work on their products. Product owners are able to evaluate yearly maintenance cost, keep track of multiple products within their household, and keep track of cumulative tax credit savings, such as from organizations such as Energy Star. In addition, all information the product owner includes in his or her profile will always be connected to the products they own. If the product owner moves, for example, a change of address in the product owner's profile will be connected to those products in his or her profile. This change may be noted by a new technician supervisor in the product owner's new geographical area so that service for the products can be consistent and constant, despite the product owner's move.

Product owners may also benefit from an aspect of the web platform called “geo-tagging” by the inventor. Geo-tagging is designed for high value products, such as jets. For such products, scanning devices, such as smartphones and tablets, will be the only access point into the web platform, and the geographical location of the scanning device will be monitored through GPS technology. The geographical location of the product with the QR Code will also be monitored. If the geographical location of the scanning device and the coded product do not align, the person operating the scanning device will be denied access to the specific product profile page. In this way, someone attempting to scan a picture of the QR Code of the product would not be able to access the information. Only someone within a geographic boundary of the product itself would be able to scan the QR Code for successful access to the information.

The geo-tagging feature may also be used for car-sharing systems. In addition to being useful for large companies, such as those branded under the trademarks ZIPCAR and CITY CARSHARE, the feature is useful for community car share systems, where a private car owner may lend out his or her car for local use. Often these systems work like a time share where people looking to borrow a car sign up for certain time periods. The geo-tagging feature would lend itself well to such car-sharing systems. First, each shared car could include a QR Code so that the geographical location of the shared car could be monitored by the car owner, for example. Car owners may only allow certain approved people to use the car. Those allowed people would use their smartphone to scan the QR Code so that the car owner is assured a verified person is using the car. Each car of car owner could include a product page within the web platform. The car owner would then have control over the scheduling of the car loaning and who the car owner will allow to borrow the car. The car may only be tracked when loaned out so that the car owner has a sense of privacy when she is using her own vehicle, and those that borrow it will know that they are being monitored. These aspects could also be paired with Near Field Communication to enable these simple transactions. One of ordinary skill in the art will recognize the possibilities in such partnerships, each of which are contemplated as being within the scope of the present invention.

Technician supervisors may benefit by being able to more accurately evaluate their technician employees' performance. This will be through access to work record information such as the time of the initial scan of the product by a technician employee and the time stamp of the ticket close-out reports provided by the technician. Technician supervisors may have access to every update, note, and tracking status made by their technicians, as well as technician workload and history, in real time. In addition, technician supervisors may easily receive job requests through the web platform. In some embodiments of the web platform, a higher level of interaction with on site technicians or product owners is allowed through the web platform. Such interaction may involve order tracking, photos, or video, for example. In addition, technician supervisors may use the web platform to organize logical geographical routes for technicians to efficiently navigate between job sites. Technician supervisors may have access to product information provided by the manufacturers, information about their technician employees, and information about specific products owned. Technician supervisors may have limited access to information about specific products. For example, while technician supervisors may have automatic access to all general product profile pages, technician supervisors may only be granted access to specific product profile pages only with the permission of the product owner or only while the technician is actually on site with the product in case the technician needs assistance. These are only a few ways in which this access may be limited. Other access limitations are also contemplated as being part of the present invention. In addition, in some embodiments, technician supervisors have full access to this information at all times.

In some embodiments, the web platform also includes a social network feature wherein the general and/or specific product profile pages are linked with other existing social networking systems, such as those marketed under the trademarks FACEBOOK and LINKED IN. All users of the web platform, product manufacturers, product owners, technician supervisors, and technicians, may use these social networking systems in relation to the web platform of the present invention. Technician supervisors may communicate with product manufacturers about new products, for example. In addition, customers can communicate that they “like” their product or technician. They can also rate their service experience. Such ratings may be viewed by other product owners looking for a technician for their own product or by technician supervisors as a means of evaluating their staff.

Technicians also benefit from the web platform. Being able to access all product information with a simple scan of the QR Code makes their jobs easier and more efficient. They never need to carry paperwork into the field concerning the product and its history because all of that information is stored on the specific product profile page. Not only do the technicians have all of their history with a specific product owned by a single owner on the specific product profile page, but the technician can also search his or her history of all like model numbers or all of the any technician's history with like model numbers. Such information may include, for example, the most ordered part for a certain product, and when in the product's life this part is usually ordered. E.g. microwave product number 567 frequently needs part 789 ordered around 4 years into its lifetime. In this way, the technician may use not only his or her own personal history with a product, but a complete history of all technicians with a product, so that the technician may observe overall trends with a certain product. This may give the technician an idea of what may be wrong with the product before he or she ever even gets on site.

Like the product owners, technicians may easily order a necessary part for repair directly through the web platform. They may feel more confident in their job knowing that their employers and their customers know that they are qualified. Technicians also benefit in automatically receiving instructions for their next job of the day after having closed out another job through the web platform. In addition, in embodiments of the web platform that include information on product certification requirements, technicians are presented with opportunities to better themselves in their field, which could lead to professional promotion. Technicians have access to specific product profile pages at least when they are on site and have scanned the QR Code of the product. In some embodiments of the web platform, they may have access at other times or all times as well, by logging into the web platform. When not on site, technicians may log into the web platform to view general product profile pages and certification opportunities.

In its most basic form, the web platform software product of the present invention includes database software code and access software code. The software product of the present invention may be executed on any number of devices, including desktops computers, laptop computers, smartphones, such as that branded as the IPHONE, and tablet notebooks, such as that branded as the IPAD.

The database software code is for maintaining the web platform database and includes general product profile page software code and specific product profile page software code. The general product profile page software code allows for creating general product profile pages by accepting general information from a number of sources including product manufacturers and other product information databases. The specific product profile page software code allows for creating specific product profile pages by accepting the general information as above, as well as specific information specific to the individual product. Specific information may be provided, for example, by scanning the product, by input from the product owner, and by input from a product technician, such as while the technician is working on the product and creating a record of the work. The specific product profile page software code includes work request software code and work recordation software code. The work request software code allows a product owner to request work on his or individual product directly through the individual product's specific product profile page. The work recordation software code allows a technician working on an individual product to record details of his or her work within the individual product's specific product profile page.

The access software code determines whether a user has access to specific product profile pages. In particular, it determines whether a technician should have access to the specific product profile page. In preferred embodiments, the access software code includes scan acceptance code, notification code, permission code, general presentation code, and specific presentation code. Scan acceptance code accepts information from the technician's scan of the product's barcode, such as time of scan, who the technician is, and which individual product it is. Notification code sends a notification to the product owner that the technician requests access to the individual product's specific product profile page. Notification code may be executed automatically upon the technician's scan of the product. Permission code allows the product owner to indicate acquiescence to the technician's access request. General presentation code presents the general product profile page to a user. Normally the general presentation code is executed upon the technician's scan of the product, whether or not he or she has been granted access to the individual product's specific product profile page. Specific presentation code presents the specific product profile page to a user. Once permission code has been executed, specific presentation code is also executed.

The access software code may also include personal technician history code and/or all technician history code. Personal technician code provides the technician with a record of that technician's past work history with a certain product model. Work history may be notes, parts ordered, how long visits took, what repairs or maintenance were performed, etc. . . . . All technician history code provides the technician with a record of all technicians' past work history with a certain product model. This gives the technician information about work on the product model beyond his or her experience. Personal technician history code and/or all technician history code may be executed upon scanning the product, along with the general product profile page, or upon receiving access to the specific product profile page.

The access software code may also include geo-tagging code that checks that the technician's physical location corresponds with the physical location of the scanned product. Geo-tagging code is executed in conjunction with geolocation features for identifying the technician's and product's location. The product's location may also be stored, rather than tracked using geolocation.

In some embodiments, the software product of the present invention also includes history storing code for recording and storing how long the technician worked on the product, what worked was performed on the product, and notes provided by the technician on the work. The method for administering the web platform of the present invention is performed by an administrator of the web platform or someone who manages the web platform. In its most basic form, the method for administering the web platform of the present invention includes the following steps: accepting general information about the various product models; creating general product profile pages for the product models including the general information; accepting specific information about individual products; creating specific product profile pages for individual products, including the specific information; providing product owners with the capability to request work on an individual product through the specific product profile page for that product; accepting the work request from the product owner; sending the work request to a technician; allowing the technician access to the specific product profile page; and storing information about work performed on the product by the technician in the specific product profile page.

In some embodiments of the method, the step of accepting specific information includes accepting information about the owner of the specific product and accepting registration information about the specific product.

In some embodiments, the step of allowing the technician access to the specific product profile page includes the steps of accepting information provided from the technician scanning the product; notifying the owner of the specific product that the technician requests access to the specific product profile page of the scanned product; providing the owner with the capability to indicate that access is granted; accepting the owner's access granted indication; and presenting the technician with the specific product profile page.

In some embodiments, the method also includes the steps of presenting the technician with the general product profile page after the step of accepting information provided from the technician scanning the product; providing the technician with a history of the technician's work on product models corresponding to the general product profile page provided; and providing the technician of a history of all technicians' work on product models corresponding to the general product profile page provided.
In some embodiments, the step of accepting information provided from the technician scanning the product includes the step of checking that the technician's physical location corresponds with the physical location of the scanned product.
In some embodiments, the step of storing information about work performed on the product by the technician comprises the steps of recording and storing how long the technician worked on the product; recording and storing what work was performed on the product; and recording and storing notes provided by the technician on the work.

The method of using the web platform of the present invention involves steps taken by the web platform master. The web platform master is the controller and manager of the web platform. The web platform method includes the steps of collecting information into a database, creating user accounts, providing access to the information, and billing for access to the information. The step of collecting information involves several substeps, including: collecting product information from product manufacturers and vendors; collecting demographic information from technicians; collecting further information about technicians from certifying authorities; collecting information about individual products; and collecting information about product certification opportunities from certifying authorities and other resources. Some of these information collection substeps, such as collecting product information from manufacturers and vendors may be automated or semi-automated. In addition, some of these substeps involve still further substeps, such as developing relationships and partnerships with manufacturers, certifying authorities, technician supervisors, etc. . . . .

The step of creating user accounts involves the web platform master creating accounts for the various types of users of the web platform. Technicians may request creation of accounts for themselves and provide basic demographic information to which credential information may be added. Product owners may request creation of an account that includes all of that product owner's products. Manufacturers may request creation of accounts that include all of the products they manufacture. Technician supervisors may request creation of accounts with links to all of their technicians and product owner clients.

The step of providing access to the information involves different substeps for the different classes of users of the web platform, including product manufacturers, product owners, technician supervisors, and technicians. As described above, different types of users may have different levels of access to different sets of information within the database, and potentially only at certain times. The step of providing access may involve steps of creating accounts, such as for technician supervisors and technicians. The type of account and type of user may define the level and type of access available to the user.

The step of billing may be performed in several ways. All manners of billing are preferably automated through the web platform. The preferred manner of performing the step of billing involves billing the technician supervisors and/or technicians a nominal monthly subscription fee, such as $5/month. Other methods of billing may include charging a fixed percentage or amount of each technician job booked through the web platform. Other methods of billing may include charging a percentage of each part ordered through the web platform, or setting prices for the parts ordered through the web platform so as to garner a profit. One of ordinary skill in the art will recognize that there are several ways in which billing may be achieved so as to make the web platform a profitable undertaking. Each of these methods of billing is contemplated as being within the scope of the present invention.

The smartphone application of the present invention utilizes scanning technology, in particular scanning technology capable of scanning QR Codes. Although labeled a “smartphone application,” it is understood that this application may be used on a smart tablet, such as that sold under the trademark “IPAD,” or similar devices capable of scanning. The smartphone application will be used primarily by technicians in the field, when they scan a code of a product upon arriving at the repair site. The smartphone application may also be used by product owners.

The smartphone application includes a number of features, including an access feature for accessing the database of the web platform. The access feature includes a limiting feature that only allows the user the level of access to which they are allowed. A technician who is not certified to work on the product may not be allowed access to the specific product profile page, for example. Alternatively, the technician's lack of certification to work on that type of product may be reported to the owner who may decide whether or not to allow the uncertified technician access to the specific product profile page. Another example of access limitation is a technician only being granted access to the specific product profile page for a window of time while he is working on the product. The smartphone application also includes a recording feature. The recording feature allows technician supervisors access to certain information about their technician's performance, such as the length of time the technician takes to perform certain jobs, and in some cases, the notes and ticket close-outs provided by the technician on site. The smartphone application may also call upon the smartphone's geolocation capabilities. The smartphone may include a navigation feature, for example, that provides the user technician with instructions on and directions to his next job after closing out the last job by scanning with the smartphone application. Geolocation capabilities are also used for the smartphone's geo-tagging feature, described above. This feature requires access to information about a product's physical location, in addition to the smartphone's physical location. The geo-tagging feature will not allow the user access to the product information unless the physical location of the product and the geolocation of the smartphone align.

The method of coding of the present invention involves including multiple layers of coding within a QR Code. This enhanced coding method allows for stronger authentication capabilities within the web platform of the present invention. The steps of the method include: accessing a QR Code that includes an authentication code; linking the QR Code with a first set of data; integrating a watermark into the QR Code; and linking the watermark within the QR Code with a second set of data. In some embodiments of the coding method of the present invention, the coding method also includes the steps of changing the authentication code of the QR Code and requiring a smartphone application to match an encryption key in order for the smartphone user to gain access to the product information. In practice, the first set of data linked with the QR Code may be a URL. The second set of data linked with the watermark may include authentication data to verify whether a smartphone application scanning the code is pirated. By changing the authentication code of the QR Code, by a technique called URL redirecting, the watermark may be linked to a private webpage. The private webpage may have an encryption key. The smartphone application would then be required to match the encryption key on the private webpage. This allows the web platform master to avoid an older and/or unauthorized version of a smartphone application on a smartphone attempting to gain access to a product through the smartphone user's scanning of the QR Code.

Therefore it is an aspect of the present invention to provide a web platform for providing access to a complete set of product information.

It is a further aspect of the present invention to provide a method for administering the web platform of the present invention.

It is a further aspect of the present invention to provide a software product for executing the web platform of the present invention through scanning.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a block diagram showing the features of the web platform of the present invention.

FIG. 2 is a block diagram showing the features of the web platform software product of the present invention.

FIG. 3 is a flow chart showing the steps of the method for administering the web platform of the present invention.

FIG. 4 is a flow chart detailing the steps involved with accessing.

FIG. 5 is a block diagram showing the database features of the web platform of the present invention.

FIG. 6 is a block diagram showing the access features of the web platform of the present invention.

FIG. 7 is a flow chart showing the steps of the method for using the web platform of the present invention.

FIG. 8 is a block diagram showing the features of the smartphone application of the present invention.

FIG. 9 is a flow chart showing the steps of the method of coding of the present invention.

### DETAILED DESCRIPTION

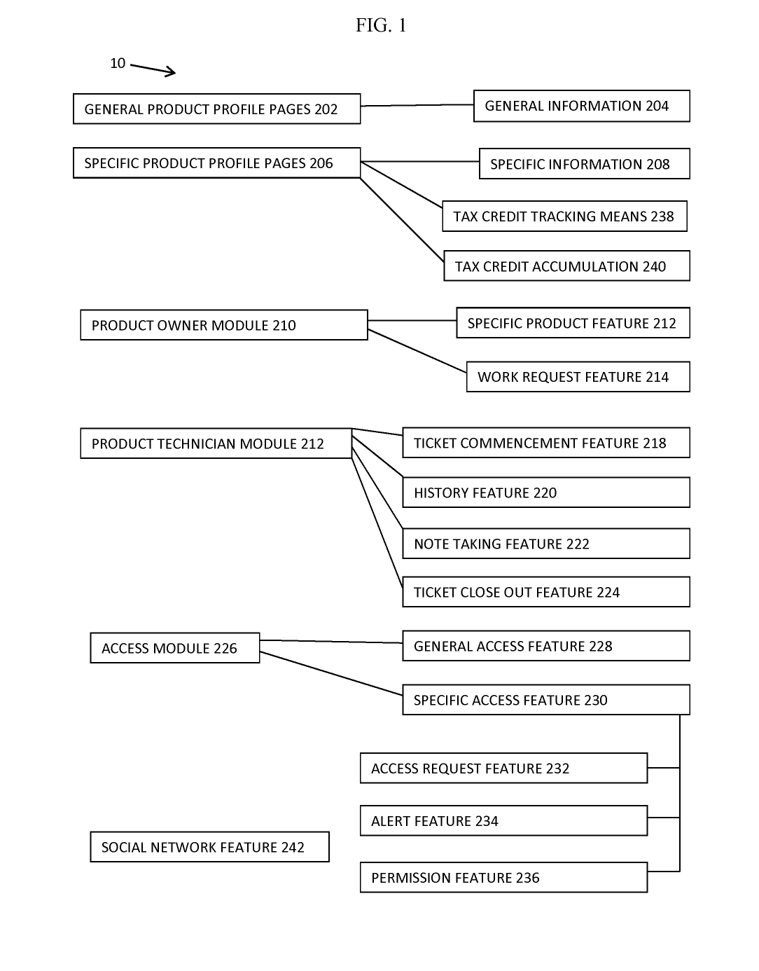

Referring first to FIG. 1, a block diagram showing the features of web platform 10 is provided. Web platform 10 includes general product profile pages 202, specific product profile pages 206, product owner module 210, product technician module 212, access module 226, and social network feature 242.

Each product included in the database of web platform 10 has a general product profile page 202. General product profile page 10 includes general information 204 common to all products of a certain model. Some of this general information 204 will be provided by manufacturers, such as specifications, maintenance recommendations, the product manual, warranty information, and links to company website support. General information 204 may also be provided by existing product databases, such as those available from AHRI, CEE, and Energy Star.

Web platform also includes specific product profile pages 206. Specific product profile pages 206 include all of general information 204 included in general product profile page 202, as well as specific information 208 specific to an individual product. Much of specific information 208 included in specific product profile page 206 is provided by product owners about the specific owned product, such as product registration information and information about the product owner. Specific product profile pages 206 may include means 238 for tracking tax credits associated with the product detailed in the specific product profile page 206. When such means 238 are included, specific information 208 includes tax credit accumulation 240 tracked by tracking means 238.

Web platform 10 also includes product owner module 210. Product owner module 210 includes specific product feature 212 and work request feature 214. Specific product feature 212 allows the product owner to enter specific information 208 about his or her individual product, as described above. Work request feature 214 allows the product owner to request repair or maintenance work on the individual product directly through the product's specific product profile page 206.

Web platform 10 also includes product technician module 212. Product technician module 212 includes ticket commencement feature 218, history feature 220, note taking feature 222, and ticket close out feature 224. Ticket commencement feature 218 time stamps when the technician began work on an individual product. Ticket commencement feature 218 is activated when the technician is granted access to the individual product's specific product profile page 206. History feature 220 gives the technician access to past technician history on the product. This may be the technician's personal history of work on any products that are the individual product's model; the technician's personal history of work on that specific individual product; all technician's history of work on any products that are the individual product's model; or all technicians' history of work on that specific individual product. Past history in this case refers to notes concerning work on the product, work performed on the product, past part requests, etc. . . . . Note taking feature 222 allows the technician to make notes on his or her present experience working on the product and to include these notes on the individual product's specific product profile page 206. Ticket close out feature 224 allows the technician to indicate completion of the work on the individual product and time stamp that completion.

Web platform 10 also includes access module 226. Access module 226 includes general access feature 228 and specific access feature 230. General access feature 228 allows users access to general product profile pages 202. In particular, when a technician scans a product, he or she will be granted access to the product's general product profile page 202. Specific access feature 230 allows users access to specific product profile pages 206. Specific access feature 230 includes access request feature 232, alert feature 234, and permission feature 236. Access request feature 232 allows the technician to request access to the individual product's specific product profile page 206. Access request feature 232 is activated when the technician scans the product. Alert feature 234 lets the owner know through web platform 10 that the technician has requested access. Permission feature 236 allows the owner to permit access once he or she is alerted as to the technician's request.

Web platform 10 also includes social network feature 238 wherein the general and/or specific product profile pages 202, 206 are linked with other existing social networking systems, such as those marketed under the trademarks FACEBOOK and LINKED IN. Customers can communicate that they “like” their product or technician. They can also rate their service experience. Such ratings may be viewed by other product owners looking for a technician for their own product or by technician supervisors as a means of evaluating their staff.

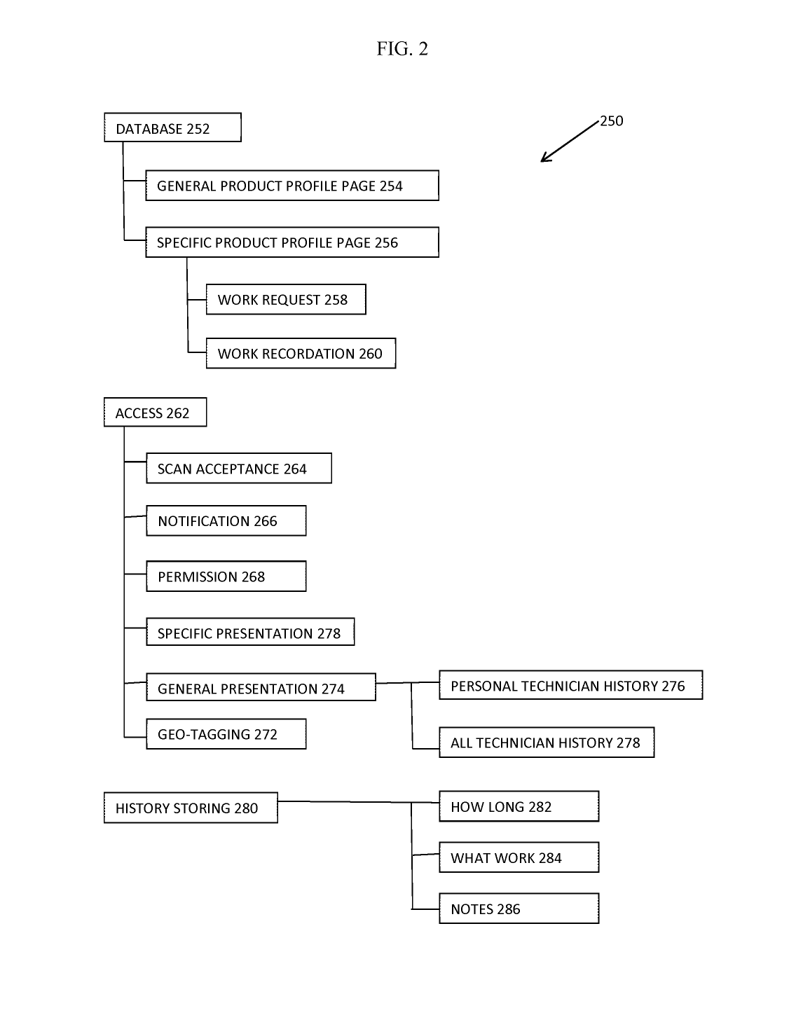

Now referring to FIG. 2, a block diagram showing the features of web platform software product 250 is provided. Web platform software product 250 includes database software code 252, access software code 262, and history storing code 280. Software product 250 may be executed on any number of devices, including desktops computers, laptop computers, smartphones, such as that branded as the IPHONE, and tablet notebooks, such as that branded as the IPAD.

Database software code 252 is for maintaining the web platform database and includes general product profile page software code 254 and specific product profile page software code 256. General product profile page software code 254 allows for creating general product profile pages by accepting general information from a number of sources including product manufacturers and other product information databases. Specific product profile page software code 256 allows for creating specific product profile pages by accepting the general information as above, as well as specific information specific to the individual product. Specific product profile page software code 256 includes work request software code 258 and work recordation software code 260. Work request software code 258 allows a product owner to request work on his or individual product directly through the individual product's specific product profile page. Work recordation software code 260 allows a technician working on an individual product to record details of his or her work within the individual product's specific product profile page.

Access software code 262 determines whether a user has access to specific product profile pages. In particular, it determines whether a technician should have access to the specific product profile page. Access software code 262 includes scan acceptance code 264, notification code 266, permission code 268, general presentation code 274, and specific presentation code 278. Scan acceptance code 264 accepts information from the technician's scan of the product's barcode, such as time of scan, who the technician is, and which individual product it is. Notification code 266 sends a notification to the product owner that the technician requests access to the individual product's specific product profile page. Notification code 266 may be executed automatically upon the technician's scan of the product. Permission code 268 allows the product owner to indicate acquiescence to the technician's access request. General presentation code 274 presents the general product profile page to a user. Normally general presentation code 274 is executed upon the technician's scan of the product, whether or not he or she has been granted access to the individual product's specific product profile page. Specific presentation code 278 presents the specific product profile page to a user. Once permission code 268 has been executed, specific presentation code 278 is also executed.

Access software code 262 also includes personal technician history code 276 and/or all technician history code 278. Personal technician code 276 provides the technician with a record of that technician's past work history with a certain product model. Work history may be notes, parts ordered, how long visits took, what repairs or maintenance were performed, etc. . . . . All technician history code 278 provides the technician with a record of all technicians' past work history with a certain product model. This gives the technician information about work on the product model beyond his or her experience. Personal technician history code 276 and/or all technician history code 278 may be executed upon scanning the product, along with the general product profile page, or upon receiving access to the specific product profile page.

Access software code 262 also includes geo-tagging code 272 that checks that the technician's physical location corresponds with the physical location of the scanned product. Geo-tagging code 272 is executed in conjunction with geolocation features for identifying the technician's and product's location. The product's location may also be stored, rather than tracked using geolocation.

Software product 250 also includes history storing code 280 for recording and storing how long the technician worked on the product 282, what worked was performed on the product 284, and notes provided by the technician on the work 286.

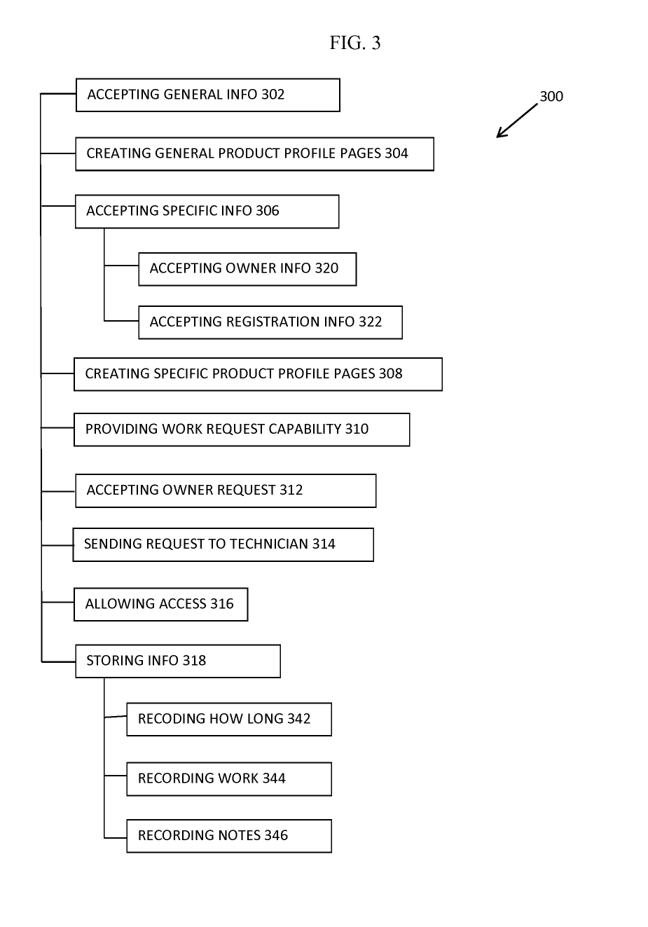

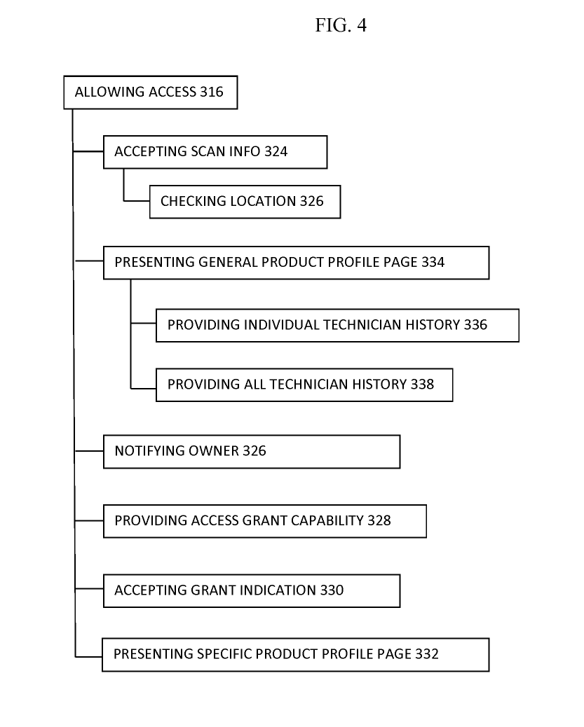

Now referring to FIGS. 3 and 4, flow charts showing the steps of method 300 for administering the web platform are provided. Method 300 for administering web platform 10 of the present invention is performed by an administrator of the web platform or someone who manages the web platform. Method 300 for administering the web platform of the present invention includes the following steps: accepting general information about the various product models 302; creating general product profile pages for the product models including the general information 304; accepting specific information about individual products 306; creating specific product profile pages for individual products 308, including the specific information; providing product owners with the capability to request work 310 on an individual product through the specific product profile page for that product; accepting the work request 312 from the product owner; sending the work request to a technician 314; allowing the technician access to the specific product profile page 316; and storing information 318 about work performed on the product by the technician in the specific product profile page.

Step 306 of accepting specific information includes accepting information about the owner 320 of the specific product and accepting registration information 322 about the specific product.

Step 316 of allowing the technician access to the specific product profile page includes the steps of accepting information provided from the technician scanning the product 324; presenting the technician with the general product profile page 334; providing the technician with a history 336 of the technician's work on product models corresponding to the general product profile page provided; and providing the technician of a history 338 of all technicians' work on product models corresponding to the general product profile page provided; notifying the owner 326 of the specific product that the technician requests access to the specific product profile page of the scanned product; providing the owner with the capability 328 to indicate that access is granted; accepting the owner's access granted indication 330; and presenting the technician with the specific product profile page 332.

When geo-tagging is used with web platform 10, step 324 of accepting information provided from the technician scanning the product includes the step of checking that the technician's physical location corresponds with the physical location of the scanned product 326.

Step 318 of storing information about work performed on the product by the technician comprises the steps of recording and storing how long the technician worked on the product 342; recording and storing what work was performed on the product 344; and recording and storing notes provided by the technician on the work 346.

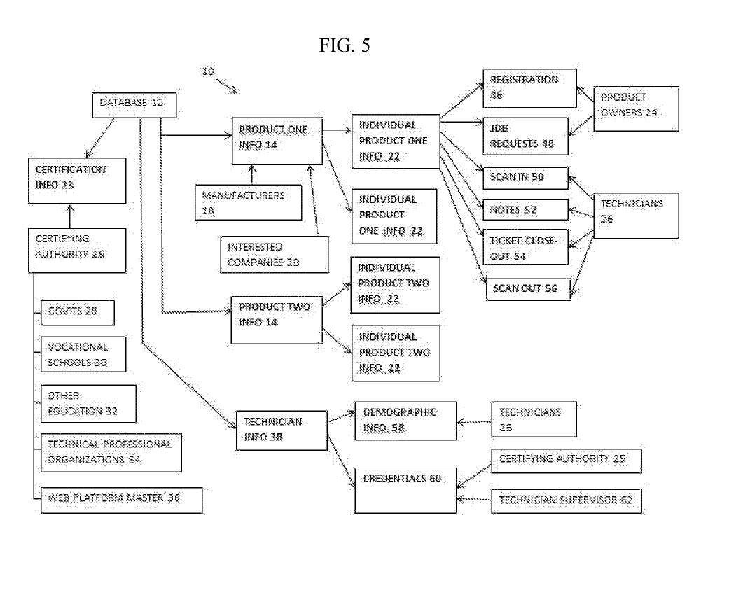

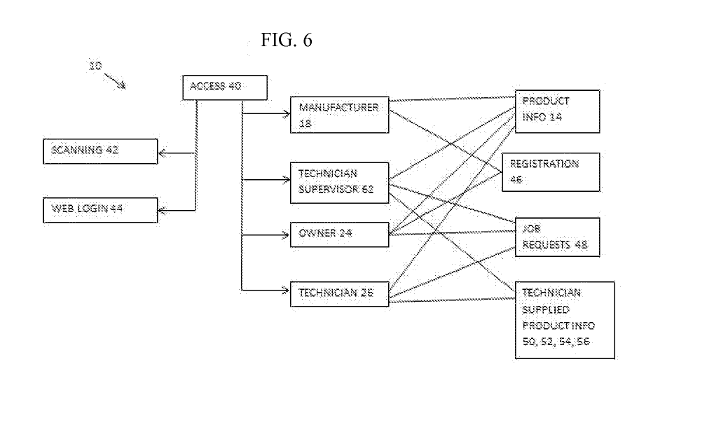

Referring now to FIGS. 5 and 6, more details of web platform 10, including database 12 and access 40 are shown. In FIG. 5, information provided to database 12 is emboldened. Other boxes show the source of that information. Information included in database 12 includes general product information 14, individual product information 22, certification information 23, and technician information 38. Product information 14 is general information about a product, such as user's manual, specifications, etc., and is provided for the most part by manufacturers 18. Interested companies 20, such as companies that may supply, sell, or manufacture parts for the product may also supply product information 14. A manufacturer 18 may supply product information 14 about every product manufacturer 18 sells. Only product information 14 for products one and two are shown, but it is understood that any number of sets of product information 14 for different products may be included in database 12. For each of products one, two, n . . . , there are specific individually owned products. Product one may be a Brand X microwave 120-A, and product information 14 is supplied by manufacturer 18 for that microwave, for example. Fifty product owners 24 that own Brand X microwave 120-A may have supplied individual product information 22 about their individual microwaves. Although only two entries of individual product information 22 are shown extending from product information 14, it is understood that for every general product information 14, there may be as many sets of individual product information 22 as there are individual products owned. The individual product information 22 provided by product owners 24 may be registration information 46 and job requests 48 for maintenance or repair of the product.

Technicians 26 also supply individual product information 22, such as scan in information 50, notes 52, ticket close-outs 54, and scan out information 56. Scan in information 50 and scan out information 56 are time records of when technician 26 scans in and out of a job. Ticket close-outs 54 provide a record of the work performed by technician 26 on the particular job for the individual product. Notes 52 are any additional notes technician 26 may include during the job through the web platform, such as suggestions for future technicians 26 that may work on the individual product. Although the different types of individual product information 22, including registration 46, job requests 48, scan in information 50, notes 52, ticket close-outs 54, and scan out information 56 are only shown as being specific to one individual product, it is understood that every individual product may have such an array of information associated with it within database 12.

Database 12 also includes information of certifications 23, supplied by a certifying authority 25. The certifying authority 25 may be a government agency or jurisdiction 28, a vocational school 30, another educational institute 32, a technical professional organization 34, or the web platform master 36. Certification information 23 is information geared toward technicians 26 and technician supervisors 62 to serve as a warehouse of information about opportunities for further certifications for technicians 26.

Database 12 also includes technician information 38. This may be basic demographic information 58, supplied by technician 26, possibly upon opening an account with web platform 10. It may also include credentials 60 of technician 26, which may include his or her background, education, service record, and product certifications. This information is likely to be supplied by a certifying authority 25 and/or a technician supervisor 62.

Now referring to FIG. 6, access 40 features of database 12 are shown. Access 40 to database 12 may be through scanning 42 a QR Code on a product or through web login 44, for those users with accounts with web platform 10. Access 40 may vary between different types of users, such as manufacturers 18, technician supervisors 62, product owners 24, and technicians 26. All users have access to general product information 14, provided by manufacturer 18. Preferably only manufacturers 18 and product owners 24 have access to registration information 46, although in some embodiments of web platform 10, product owners 24 may allow access to registration information 46 to other users. Product owners 24 have access to all information available about their products. Technician supervisors 62 and technicians 26 also have access to job requests 48. Technicians 26 and preferably technician supervisors 62 also have access to technician supplied product information, such as scan in information 50, ticket close-outs 52, scan out information 54, and notes 56. Levels of access 40 may vary depending on preferences of users, in particular product owners 24. Product owners 24 may allow more or less access to the different types of users. One of ordinary skill in the art will recognize that there are many combinations of access 40 between the different types of information stored in database 12 and the different types of users. It is also understood that access 40 may include varying levels of being able to view information versus being able change, add, or delete information. A technician 26, for example, may view his credentials 60, but only a certifying authority 23 may change, add to, or delete the credentials 60 of technician 26.

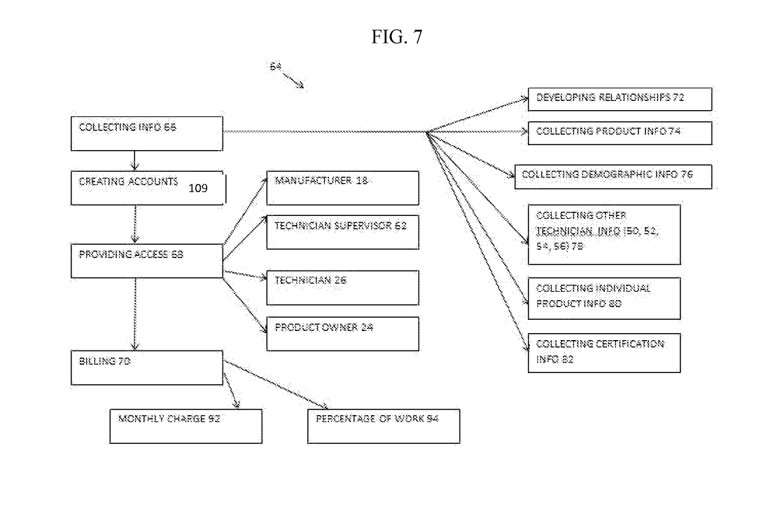

Now referring to FIG. 7, method 64 for using web platform 10 of the present invention is shown. Web platform 64 is performed by a web platform master. The basic steps of web platform method 64 are collecting information 66, creating accounts 109, providing access 68, and billing 70. The step of collecting information 66 may include the substeps of building relationships 72 with certifying authorities 25, for example; collecting general product information 74 from manufacturers 18; collecting demographic information 76 from technicians 26; collecting other technician provided information 78, such as scan in information 50, ticket close-outs 52, scan out information 54, and notes 56; collecting information about individual products 80, such as registration information 46 and job request information 48, from product owners 24; and collecting certification information 82 from certifying authorities 25. The step of providing access 68 involves providing access to the information in database 12 to the various types of users of web platform 10, including manufacturers 18, technician supervisors 62, technicians 26, and product owners 24. Different types and levels of access 40 are described above with reference to FIG. 6. The step of billing 70 involves making money from web platform 10. Billing step 70 may be achieved in many ways, two of which are billing a monthly charge 92 to technicians 26 and/or technician supervisors 62, and billing a percentage 94 of fees collected by technician supervisors 62 from jobs booked through web platform 10.

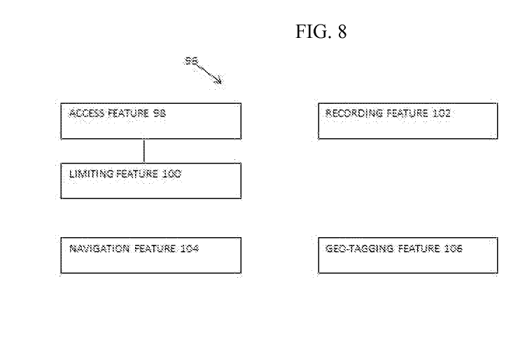

Now referring to FIG. 8 features of smartphone application 96 are shown. These features include access feature 98 with limiting feature 100, recording feature 102, navigation feature 104, and geo-tagging feature 106. Access feature 98 is for accessing database 12 of web platform 10 by scanning the code, preferably a QR Code on a product. Access feature 98 includes limiting feature 100 that only allows the user the level of access to which they are entitled. Recording feature 102 allows technician supervisors 62 access to certain information about their technicians' performance, such as the length of time technician 26 takes to perform certain jobs, and in some cases, the notes 56 and ticket close-outs 52 provided by technician 26 on site. Navigation feature 104 provides technician 26 with instructions on and directions to his next job after closing out the last job by scanning with smartphone application 96. Geo-tagging feature 106 requires access to information about a product's physical location, in addition to the smartphone's physical location. Geo-tagging feature 106 will not allow the user access to the product information unless the physical location of the product and the geolocation of the smartphone align.

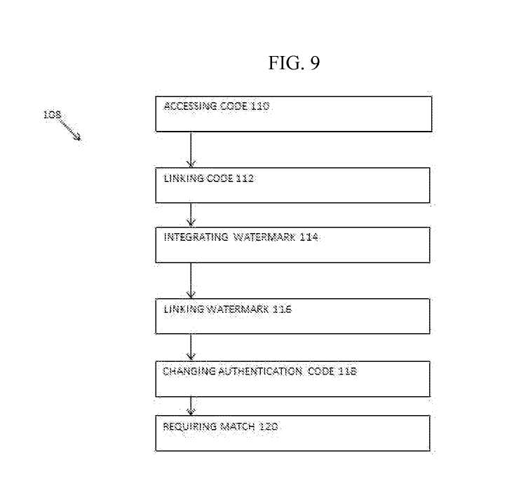

Now referring to FIG. 9, the steps of method 108 of coding of the present invention are shown. The steps include: accessing a QR Code 110 that includes an authentication code; linking the QR Code 112 with a first set of data; integrating a watermark 114 into the QR Code; and linking the watermark 116 within the QR Code with a second set of data. In some embodiments of coding method 108 of the present invention, coding method 108 also includes the steps of changing the authentication code 118 of the QR Code and requiring a smartphone application to match 120 an encryption key in order for the smartphone user to gain access to the product information.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

We claim:

1. A web platform for facilitating product information sharing between at least product owners and product technicians comprising:
a plurality of general product profile pages, each of which includes general information pertaining to a particular product model;
a plurality of specific product profile pages, each of which includes the general information pertaining to a particular product model and specific information pertaining to an individual product that is the particular product model about which the general information pertains;
a product owner module comprising:
a specific product feature for entering information about the individual product owned by the product owner into one of said plurality of specific product profile pages; and
a work request feature for requesting work to be performed on the individual product;
a product technician module comprising:
a ticket commencement feature for time stamping a commencement of work on the individual product;
a history feature for allowing the product technician access to a history of work pertaining to the product model and individual product;
a note taking feature for entering notes about work on the individual product; and
a ticket close out feature for time stamping a completion of work on the individual product;
an access module for allowing the product technician access to product information comprising:
a general access feature for allowing the product technician access to the one of said plurality of general product profile pages pertaining to the product model of the individual product; and
a specific access feature for allowing the product technician access to the one of said plurality of specific product profile pages pertaining to the individual product, said specific access feature comprising:
an access request feature for requesting access to the one of said plurality of specific product profile pages pertaining to the individual product;
an alert feature for alerting the product owner of the access request; and
a permission feature for permitting access to the product technician to the one of said plurality of specific product profile pages pertaining to the individual product.

2. The web platform as claimed in claim 1, wherein at least one of said plurality of specific product profile pages comprises means for tracking tax credits associated with the individual product and said specific information about the individual product comprises tax credit accumulation.

3. The web platform as claimed in claim 1, further comprising a social network feature wherein one of a group consisting of said plurality of general product profile pages and said plurality of specific product profile pages is linked to an online social networking website.

4. A web platform software product for facilitating product information sharing, storable on a computer readable medium and executable by a server, comprising:
database software code for maintaining a database comprising:
general product profile page software code for creating general product profile pages including information on specific product models; and
specific product profile page software code for creating specific product profile pages including information on specific individual products, wherein said specific product profile page software code comprises:
work request software code for allowing a product owner to request work on the individual product through the individual product's specific product profile page and sending the work request to a technician; and
work recordation software code for recording a history of work performed on the individual product; and
access software code for determining whether a user has access to specific product profile pages.

5. The software product as claimed in claim 4, wherein said software product is executable on one of the group consisting of a desktop computer, a laptop computer, a smartphone, and a tablet.

6. The software product as claimed in claim 4, wherein said access software code comprises:
scan acceptance code for accepting information from a technician's scan of a product;
notification code for notifying a product owner that the technician desires access to the product's specific product profile page;
permission code for allowing the product owner to allow the technician access to the product's specific product profile page; and
specific presentation code for presenting the technician with the product's specific product profile page.

7. The software product as claimed in claim 6, wherein said access code further comprises geo-tagging code for checking that the technician's physical location corresponds with the physical location of the scanned product.

8. The software product as claimed in claim 4, wherein said access code comprises general presentation code for presenting a user with a product's general product profile page.

9. The software product as claimed in claim 8, wherein said access code further comprises personal technician history code for providing the technician with a record of the technician's own history of work on product models corresponding to the general product profile page.

10. The software product as claimed in claim 9, wherein said access code further comprises all technician history code for providing the technician with a record of all technicians' history of work on product models corresponding to the general product profile page.

11. The software product as claimed in claim 4, further comprising history storing code for recording and storing how long the technician worked on the product; what work was performed on the product; and notes provided by the technician on the work.

12. A method for using a web platform comprising the steps of:
accepting general information about a plurality of product models;
creating a plurality of general product profile pages, wherein each of the general product profile pages pertains to an individual product model and includes the general information about the product models accepted in said accepting general information step;
accepting specific information about a plurality of individual products, each with a specific serial number, wherein each product with a specific serial number is one of the product models about which a general product profile page has been created in said creating a plurality of general product profile pages step;
creating a plurality of specific product profile pages including the specific information accepted during said accepting specific information step;
providing product owners with the capability to request work on an individual product with a specific serial number through the specific product profile page for that product;
accepting the work request from the product owner
sending the work request to a technician;
allowing the technician access to the specific product profile page; and
storing information about work performed on the product by the technician in the specific product profile page.

13. The method as claimed in claim 12, wherein said step of accepting specific information about a plurality of individual products comprises the steps of:
accepting information about the owner of the specific product; and
accepting registration information about the specific product.

14. The method as claimed in claim 12, wherein said step of allowing the technician access to the specific product profile page comprises the steps of:
accepting information provided from the technician scanning the product;
notifying the owner of the specific product that the technician requests access to the specific product profile page of the scanned product;
providing the owner with the capability to indicate that access is granted;
accepting the owner's access granted indication; and
presenting the technician with the specific product profile page.

15. The method as claimed in claim 14, further comprising the step of presenting the technician with the general product profile page after said step of accepting information provided from the technician scanning the product.

16. The method as claimed in claim 15, further comprising the step of providing the technician with a history of the technician's work on product models corresponding to the general product profile page provided.

17. The method as claimed in claim 16, further comprising the step of providing the technician of a history of all technicians' work on product models corresponding to the general product profile page provided.

18. The method as claimed in claim 14, wherein said step of accepting information provided from the technician scanning the product comprises the step of checking that the technician's physical location corresponds with the physical location of the scanned product.

19. The method as claimed in claim 12, wherein said step of storing information about work performed on the product by the technician comprises the steps of:
recording and storing how long the technician worked on the product;
recording and storing what work was performed on the product; and
recording and storing notes provided by the technician on the work.
